(19) United States
(12) Patent Application Publication
(10) Pub. No.: US 2013/0181097 A1
(43) Pub. Date: Jul. 18, 2013

(54) Conduit and Stanchion for Photovoltaics

(71) Applicant: Scuint Corporation, Austin, TX (US)

(72) Inventor: Steven B. Snidow, Austin, TX (US)

(73) Assignee: Scuint Corporation, Austin, TX (US)

(21) Appl. No.: 13/744,390

(22) Filed: Jan. 17, 2013

Related U.S. Application Data
(60) Provisional application No. 61/588,135, filed on Jan. 18, 2012.

(51) Int. Cl. F16M 13/02

(52) U.S. Cl. CPC F16M 13/02
USPC 248/121

(57) ABSTRACT

A connection device for photovoltaic panels and related devices providing for the electrical, or other, interconnection of photovoltaic panels and related devices to other devices through structural and non-structural stanchions that act in an additional capacity as conduit.

### CROSS-REFERENCE TO RELATED APPLICATIONS

This application claims the benefits of the filing of U.S. Provisional Patent Application Ser. No. 61/588,135 entitled, Conduit and Stanchion for Photovoltaics, filed Jan. 18, 2012 and the specification thereof is incorporated herein by reference.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### TECHNICAL FIELD

The present invention is in the technical field of photovoltaic devices. More particularly, the present invention is in the technical field of the support and interconnection structure of photovoltaic panels. More particularly, the present invention is in the technical field of vertical support devices used to connect one, or more, solar photovoltaic panels to a fixed surface such as a roof.

### BACKGROUND OF THE INVENTION

Conventional methods of connecting photovoltaic panels to a surface vary greatly and may include simple standalone systems such as legs allowing a panel to be placed non-permanently, much as a table on the ground or other flat, or near-flat, surface, to more complicated metal and machined devices for surfaces such as roofs or other surfaces that may also be inclined. Many conventional methods to secure photovoltaic panels to a sloped roof include a system of connecting multiple vertical posts to the roof and then connecting one, or more, horizontal tracks to a plurality of those vertical posts effecting an armature to which photovoltaic panels may be secured. An important factor in existing “post and track” systems is the requirement to place electrical, or other, wires and cables to the exterior of the structure, such as a house, and exposing those wires, and cables, to risk of damage through outdoor factors including weather and animals.

Many current “post and track” systems include posts are designed for strength and for faster installation. These designs typically result in solid machined metal posts, or stanchions, with unique connecting ends that provide for a “quick connect” to the roof and then to either the track or directly to the panel(s) and without sacrificing structural integrity and strength. Many such designs have been awarded patents such as those listed below.

U.S. Pat. No. 7,918,221 (Warfield et al; Apr. 5, 2011) teaches us of a mounting system that is comprised primarily of a “V” shaped element forming an elongated grove that can be affixed to a substrate, such as a roof, through holes at the apex, or bottom, of the “V” and with a device to attach the individual photovoltaic panels to the top of the “V” that is shaped to have flanges onto which the device can effectively connect photovoltaic panels. This patent reflects a design that utilizes a relatively large amount of material to form the “V” track and that does not show additional purpose to the purpose of mounting.

U.S. Pat. No. 7,797,883 (Tarbell et al; Sep. 21, 2010) teaches of a photovoltaic panel mounting system comprised of an inverted “T” shaped track that is positioned above roof sheathing, such as Oriented Strand Board (OSB), and below tiles or shingles of the roof. The “T” shaped track is fastened through the roof sheathing to the roof support member, such as a rafter, by means of a screw. A second screw, or bolt, is inverted such that its threaded end is pointed upward and accepts a vertical post whose purpose appears to be to gain height above the sheathing and or shingles (tile). Once in position, the “T” shaped track is covered with shingles (roof tiles) and the vertical post is put through a hole in the shingle (roof tile) such that the roofing material can lay naturally on the roof sheathing. On the top of the vertical post, a second track is connected by means of another screw (bolt) thus allowing for connection to the photovoltaic panel(s). Flashing is mounted onto the vertical post to help weatherproof the invention. This patent reflects a design with utility primarily as a support structure.

U.S. Pat. No. 6,360,491 (Ullman; Mar. 26, 2002) teaches us of a photovoltaic panel mounting system comprised of a mounting plate affixed by means of screws or nails through roof sheathing to a rafter, or similar, support member and that is formed such that it acts as a female end to receive a threaded male end to form the base of a vertical post and wherein the male end component forms the vertical post. The system is then comprised of a flashing component that covers the whole and a horizontal track that is connected to a plurality of female-male posts, with flashing, and onto which the photovoltaic panel(s) are connected. This patent reflects a design that has utility but that lacks additional utility to that beyond of a support, or mounting, system.

U.S. Pat. No. 7,921,607 (Thompson et al; Apr. 12, 2011) teaches us of a mounting system that can be used for the mounting of photovoltaic panels and that is comprised of a metal base plate that has a circular hole and slot through which lag bolts can be placed to affix the metal plate to a roof and presumably a rafter. The metal plate is fitted with a vertical bolt that is threaded and to which a “U” shaped device is connected and in which the “U” shaped device is placed onto the vertical, threaded, post in an inverted position and secured to the metal plate by use of a nut tightened through a hole in the “U” shaped structure and through which the vertical post is placed. The “U” shaped device (structure) can be tightened providing for tension and as shown in this patent can allow for flashing to be placed between the original metal plate and the “U” shaped cap. Photovoltaic panels, or other, can be then attached to the top of the inverted “U” shaped structure. This patent has utility primarily as a mounting system.

U.S. Pat. No. 6,576,830 (Nagano et al; Jun. 10, 2003) teaches of a more unique approach to the common issue of wire connection from the photovoltaic panel(s) to a battery system, house electrical system or other electrical system (e.g., grid). The approach taken by Nagano et al is to provide for the photovoltaic panel wiring to be placed through a hole in the roof. The Nagano et al invention does not explicitly claim a hole in the roof for the purposes of placing electrical wires alone and, instead, places emphasis on the running of electrical wire through the hole and then sealing the hole with a sealing material and claiming many attributes of the sealing material. While this patent appears to recognize the utility of placing the electrical wiring from a photovoltaic panel directly beneath the panel and through the roof structure, this patent does not utilize structural elements of a panel mounting system to achieve that utility.

### SUMMARY OF THE INVENTION

The present invention is a hollow vertical tube that is machined, or otherwise formed, and configured to act as a vertical post allowing for connection to a substrate, such as a sloped roof, on one end and being connected on the other end to a solar device such as a photovoltaic panel(s) and in such a manner that the vertical tube acts additionally as a conduit, housing, post, or stanchion, and whose hollow cavity allows for wiring, cabling, tubing, electronics or interconnection of the panel(s) to other devices or end uses through the stanchion and in such a manner that the structural properties of the stanchion are sufficient for structural installation and support purposes of the photovoltaic panel(s).

### BRIEF DESCRIPTION OF THE SEVERAL VIEWS OF THE DRAWING

FIG. 1 is a side view showing two existing approaches for the design of and mounting of a stanchion for the further mounting of photovoltaic panel(s);

FIG. 2 is a side view of the present invention with flush mount;

FIG. 3 is a side view of the present invention with penetrated mount;

FIG. 4 is a side view of the present invention with penetrated mount and alternative connection;

FIG. 5 is a perspective view of typical roof showing the respective, and relative, placement of the present invention as flush mount or penetrated mount; and

FIG. 6 is a side view of the present invention with an illustration of wiring, cabling and/or tubing placed within and through the present invention.

### DETAILED DESCRIPTION OF THE INVENTION

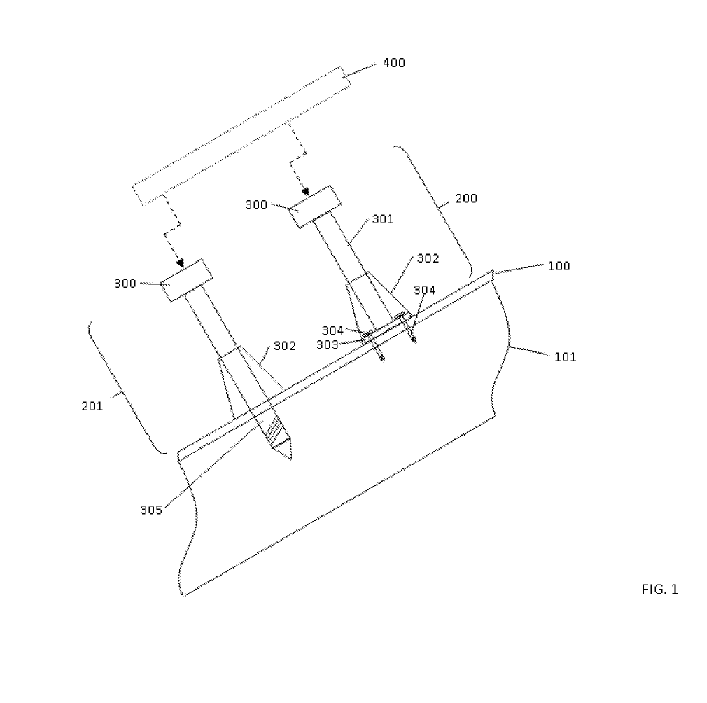

Referring now to existing stanchion designs, in FIG. 1 there are two typical stanchions 200 and 201 that are using different approaches to be mounted to a roof where the roof is comprised of roof decking, or sheathing, 100 affixed to a support member, such as a rafter, 101. Stanchion 200 is comprised of a roof-mounted plate 303 affixed to the roof deck 100 and rafter 101 by means of a plurality of screws 304. The vertical support stanchion is either a solid member or hollow member 301 secured by any means to the roof-mount plate 303 and a track, or panel, mount bracket 300. The stanchion is typically comprised to include flashing 302 for weatherproofing. Item 400 represents a track or other device, such as a photovoltaic panel, secured to stanchion 200 by other means.

Still referring to FIG. 1, existing stanchion design 201 is comprised of many of the same elements as stanchion 200 including flashing 302 and rack/panel mounting bracket 300. Stanchion 201 is different from stanchion 200 in that the vertical support piece is comprised of a single member, such as a lag screw, 305 that is secured into the roof through decking 100 and into structural support 101. Vertical support member 305 is solid. Item 400 represents a track or other device, such as a photovoltaic panel, secured to stanchion 201 by other means.

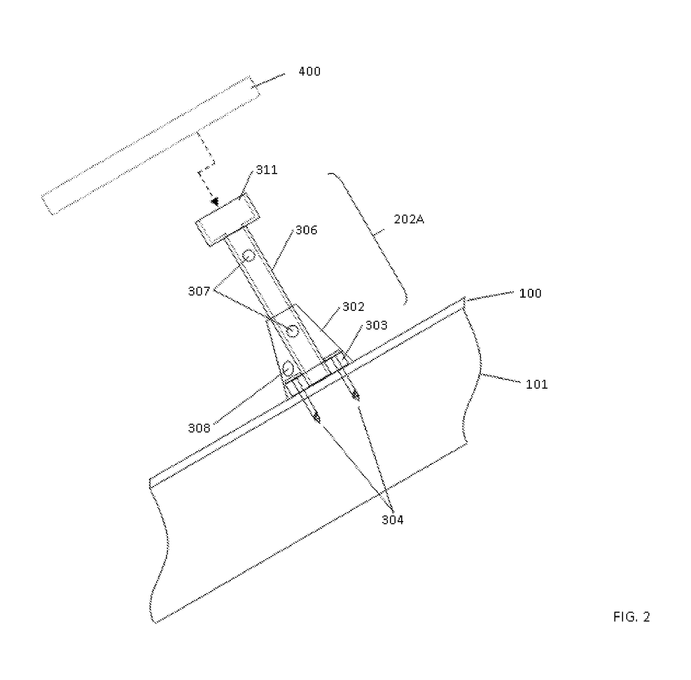

Referring now to the present invention, in FIG. 2 there is shown a hollow vertical element 306 that may be used for primary support of a mounted track and/or device such as a photovoltaic panel. Similar to stanchion 200 shown in FIG. 1, the stanchion 202A shown in FIG. 2 is also flush mounted to the roof and, overall, comprised of the same elements including roof mounting plate 303 secured to roof deck 100 and roof support member 101 by screws 304 and with flashing 302. Hollow vertical element 306 is connected to rack/panel mounting bracket 311 that is shown in FIG. 2 as hollow but may be solid or of traditional configuration. Vertical element 306 is shown with holes 307 that are shown as circular but represent any hole, cut, notch or slit that penetrates the wall of 306 and through which wiring, cabling, tubing, or other, may be placed such that the cavity of vertical element 306 may be used to house or act as a conduit for such wires, cable, tubes or other. Similarly, flashing 302 is shown with a hole 308 made available to extend the principle of providing within the stanchion access for wires, cables, tubes, or other, to be placed. While vertical element 306 and flashing 302 are shown with limited holes 307 and 308, any count of holes, of any shape and placement, may be utilized. Item 400 represents a track or other device, such as a photovoltaic panel, secured to stanchion 202A by other means.

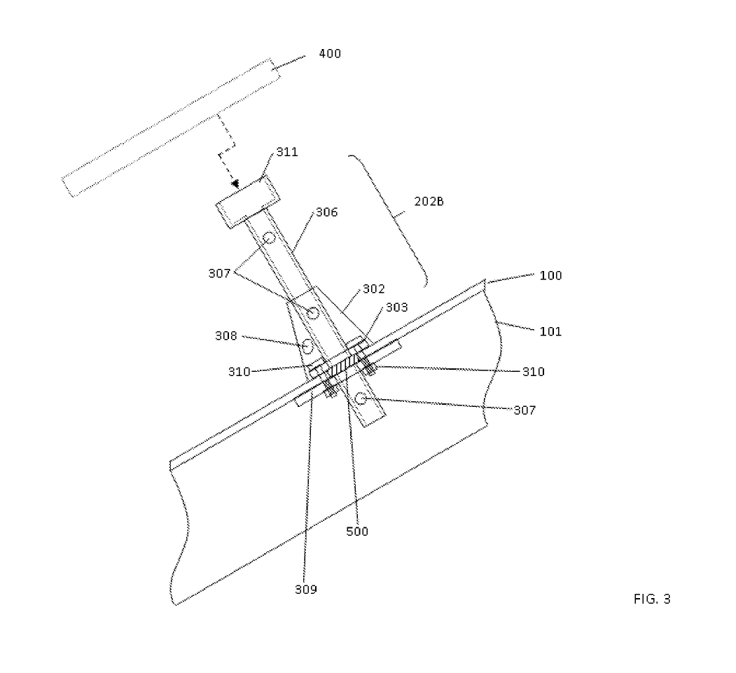

Referring now to the present invention with alternative utility, in FIG. 3 there is shown a hollow vertical element 306 that may be used for primary support of a mounted track and/or device such as a photovoltaic panel. Different from stanchion 200 shown in FIG. 1, the stanchion 202B shown in FIG. 3 is not flush mounted to the roof but, instead, is a penetrated mount placed through roof deck 100 and through hole 500. Stanchion 202B is mounted to roof deck 100 using a top mounting plate 303 and interior mounting plate 309 secured together by a plurality of bolt and nut sets 310 and utilizing flashing 302. Hollow vertical element 306 is connected to rack/panel mounting bracket 311 that is shown in FIG. 3 as hollow but may be solid or of traditional configuration. Vertical element 306 is shown with holes 307 that are shown as circular but represent any hole, cut, notch or slit that penetrates the wall of 306 and through which wiring, cabling, tubing, or other, may be placed such that the cavity of element 306 may be used to house or act as a conduit for such wires, cable, tubes or other. Similarly, flashing 302 is shown with a hole 308 made available to extend the principle of providing within the stanchion access for wires, cables, tubes, or other, to be placed. While vertical element 306 and flashing 302 are shown with limited holes 307 and 308 any count of holes, of any shape and placement, may be utilized. Specifically, holes, cuts, notches or slits may exist above and below the roof deck 100. Item 400 represents a track or other device, such as a photovoltaic panel, secured to stanchion 202B by other means. Stanchion 202B can alternatively be understood to not have the utility of photovoltaic panel structural support and only the utility of a penetrated conduit to a photovoltaic panel.

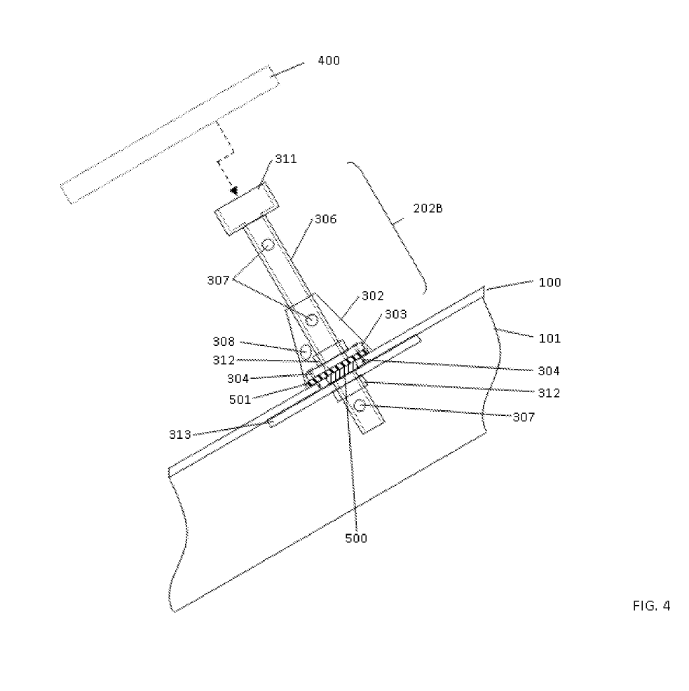

Referring now to the present invention in FIG. 4, there is shown stanchion 202B as shown in FIG. 3 but with alternative mounting method. As before, a hollow vertical element 306 that may be used for primary support of a mounted track and/or device such as a photovoltaic panel, is a penetrated mount placed through roof deck 100 and through hole 500. Stanchion 202B is mounted to roof deck 100 using top mounting plate 303 secured to roof deck 100 by a plurality of screws 304 and shown with a weatherproofing sealant, such as a gasket, 501. Stanchion 202B is further secured into place by use of collars 312 that are be secured into fixed position such as connection to the mounting plate 303, the roof deck 100 or to each other. Support plate, or bracket, 313 provides stanchion 202B support from vertical uplift such as that from wind or tampering and theft. Hollow vertical element 306 is connected to rack/panel mounting bracket 311 that is shown in FIG. 4 as hollow but may be solid or of traditional configuration. Vertical element 306 is shown with holes 307 that are shown as circular but represent any hole, cut, notch or slit that penetrates the wall of 306 and through which wiring, cabling, tubing, or other, may be placed such that the cavity of element 306 may be used to house or act as a conduit for such wires, cable, tubes or other. Similarly, flashing 302 is shown with a hole 308 made available to extend the principle of providing within the stanchion access for wires, cables, tubes, or other, to be placed. While vertical element 306 and flashing 302 are shown with limited holes 307 and 308 any count of holes, of any shape and placement, may be utilized. Specifically, holes, cuts, notches or slits may exist above and below the roof deck 100 and understood to represent any penetrable surface. Item 400 represents a track or other device, such as a photovoltaic panel, secured to stanchion 202B by other means. It should be further understood that collars 312 and/or support plate, or bracket, 313 may be secured to stanchion 202B so as to act as a tampering or theft deterrent.

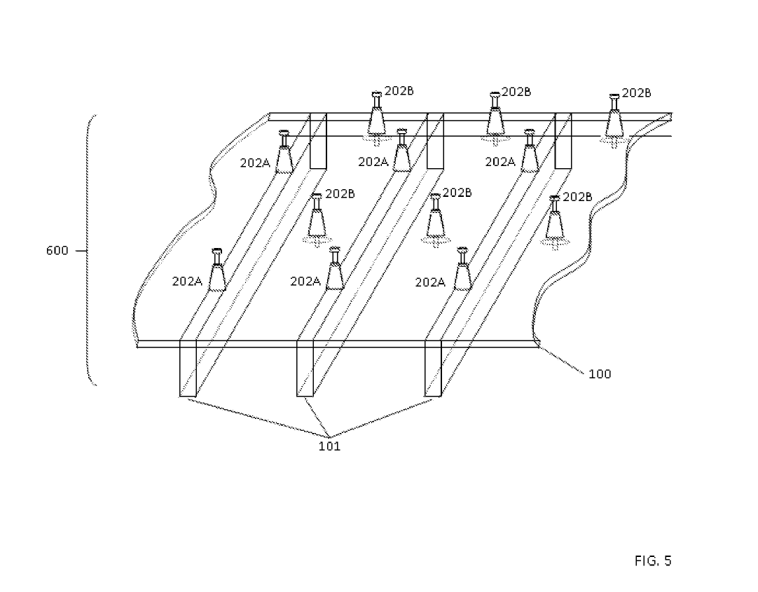

Referring now to FIG. 5, there is shown a perspective view of a section of a typical framed roof 600 comprised of roof deck 100 and a plurality of support members, such as rafters, 101. The present invention as a flush mount stanchion 202A and as a penetrated mount stanchion 202B are both shown to provide a fuller understanding of the relative placement of each stanchion, 202A and 202B, to the different roof 600 elements 100 and 101 with specific reference to stanchion 202B that is not placed directly over rafters 101 that are understood to represent solid structural support members.

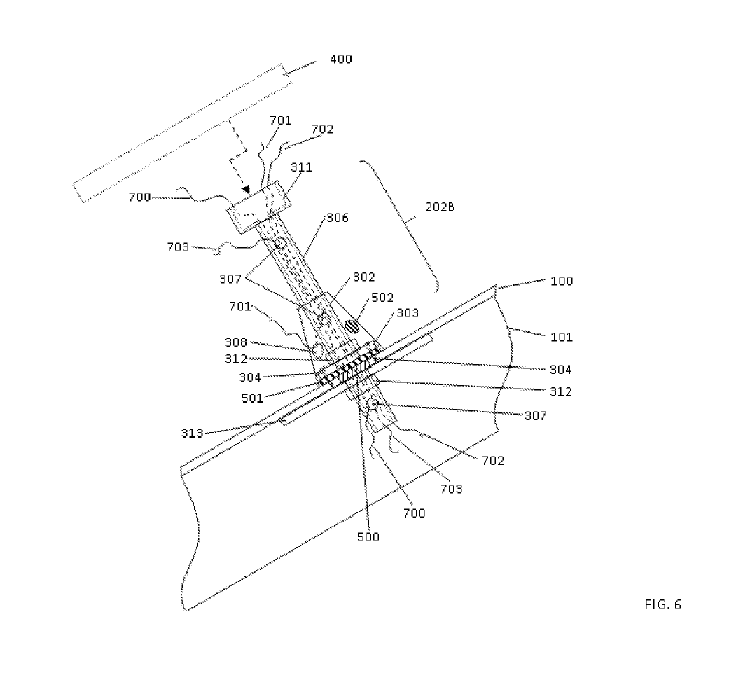

Referring now to FIG. 6, there is shown a side view of the present invention, as shown in FIG. 4, with stanchion 202B comprised of vertical element 306, top mounting plate 303 secured to roof deck 100 by a plurality of screws 304 and shown with a weatherproofing sealant, such as a gasket, 501. Stanchion 202B is further secured into place by use of collars 312 that are be secured into fixed position such as connection to the mounting plate 303, the roof deck 100 or to each other. Support plate, or bracket, 313 provides stanchion 202B support from vertical uplift such as that from wind or tampering and theft. Hollow vertical element 306 is connected to rack/panel mounting bracket 311 that is shown in FIG. 6 as hollow but may be solid or of traditional configuration. Vertical element 306 is shown with holes 307 that are shown as circular but represent any hole, cut, notch or slit that penetrates the wall of 306 and through which wiring, cabling, tubing, or other, may be placed such that the cavity of element 306 may be used to house or act as a conduit for such wires, cable, tubes or other. Similarly, flashing 302 is shown with a hole 308 made available to extend the principle of providing within the stanchion access for wires, cables, tubes, or other, to be placed. For illustration purposes only, and to further the understanding of the present invention, stanchion 202B is shown with wires, or cables or tubes, 700, 701, 702 and 703 that are positioned to make use of the terminal ends of vertical support element 306 as well as holes 307 in support element 306 and the holes 308 in flashing 302. For additional illustration purposes, gasket 502 is shown to seal one example hole 308 and is understood may be used for one, or more, holes 307 or 308 that are vacant or through which wire(s), cable(s) or tube(s) may be positioned. Further, while a total of four wires, cables or tubes 700, 701, 702 and 703 are reflected in FIG. 6, they are to represent any one, or more, wires, cables or tubes as may be required for end use purposes.

The advantages of the present invention include, without limitation, the ability to reduce the exposure of wiring, tubing and/or cabling to weathering, animal and other outdoor factors while still providing structural support and also providing an alternative method to reduce the total amount of wiring, tubing and/or cabling required for the mounting of photovoltaic panel(s).

In broad embodiment, the present invention is an alternative method for securing photovoltaic panels onto a structure.

### DESCRIPTION OF THE PREFERRED EMBODIMENTS

### Best Modes for Carrying Out the Invention

The present invention should be understood to provide for the combined utility of structural support for the mounting of photovoltaic devices onto a structure while, additionally, providing the means to act as a protective conduit and/or housing for electrical and non-electrical wires and/or cables that may interconnect one, or more, photovoltaic panels to one another and/or to a battery storage system and/or directly to a primary electrical system (e.g., connection to the grid).

The present invention is first comprised of a hollow metal tube, or conduit, that is has sufficient structural integrity to, when used with other support structures, provide the ability to lift and hold a photovoltaic panel. The present invention is further comprised by one, or more, means to secure the conduit portion to a roof, or other structure, where such means include metal plates, collars, screws and/or nut and bolt combinations. The present invention is further comprised of a second connecting end whose purpose is to attach to and secure a photovoltaic panel. The panel connecting end may be an additional device attached to the conduit or an integrated element of the conduit piece.

The present invention may be a substitute for existing photovoltaic panel support stanchions alone or it may be a substitute for existing stanchions and for methods, or devices, for electrically interconnecting photovoltaic panels.

### INDUSTRIAL APPLICABILITY

The invention is further illustrated by the following non-limiting examples.

### Example 1

The present invention may act as a stanchion to a photovoltaic panel wherein the present invention is used singularly, or in multitude, as the primary means to secure a photovoltaic panel to a structure such as a house or commercial building. In such example, the present invention is comprised of three primary portions: mounting base, conduit and physical connection. First, the mounting base would be secured to the structure (e.g., roof) by means described herein and the vertical conduit portion placed into the mounting base. The physical connection piece will then be secured to the opposite end of the hollow conduit portion and providing a means by which a photovoltaic panel can be secured to each, individual stanchion.

### Example 2

The present invention may act as a stanchion to a photovoltaic panel and a means for placing electrical wires wherein the present invention is used singularly, or in multitude, as the primary means to secure a photovoltaic panel to a structure such as a house or commercial building. In such example, the present invention is comprised of three primary portions: mounting base, conduit and physical connection. First, the mounting base would be secured to the structure (e.g., roof) by means described herein and the vertical conduit portion placed into the mounting base and through the surface of the roof. The physical connection piece will then be secured to the opposite end of the hollow conduit portion and providing a means by which a photovoltaic panel can be secured to each, individual stanchion. Once the photovoltaic panel is placed, an electrician, or other, can place electrical wires originating from the photovoltaic panel into an aperture in the conduit portion and through the conduit portion allowing for such wires to exit the opposite end of the conduit and, whereby, the ends of those wires are placed through the penetrated surface and within the structure (e.g., such as the attic of a residence) and where all such wires can be interconnected in a protected environment.

### Example 3

The present invention may act as a stanchion to a photovoltaic panel and a means for placing electrical wires wherein the present invention is used singularly as and means of providing an electrical interconnection and not as the primary means to secure a photovoltaic panel to a structure and where such means of securing can be understood to be provided by conventional mounting stanchions. In such example, the present invention is comprised of three primary portions: mounting base, conduit and physical connection. First, the mounting base would be secured to the structure (e.g., roof) by means described herein and the vertical conduit portion placed into the mounting base and through the surface of the roof. The physical connection piece will then be secured to the opposite end of the hollow conduit portion and providing a means by which a photovoltaic panel can be secured to each, individual stanchion. Once the photovoltaic panel is placed, an electrician, or other, can place electrical wires originating from the photovoltaic panel into an aperture in the conduit portion and through the conduit portion allowing for such wires to exit the opposite end of the conduit and, whereby, the ends of those wires are placed through the penetrated surface and within the structure (e.g., such as the attic of a residence) and where all such wires can be interconnected in a protected environment. In this example, the present invention is used as an add-on device to existing means of securing a photovoltaic panel.

The preceding examples can be repeated with similar success by substituting the generically or specifically described parameters and/or operating conditions of this invention for those used in the preceding examples.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A mounting stanchion for the mounting of photovoltaic panels that is comprised of a hollow element that is a structural component for the overall purpose of mounting and whose terminal ends may be used for the transit of wires, cables or tubes from photovoltaic panel through stanchion and to other devices;

2. A mounting stanchion for the mounting of photovoltaic panels and that is comprised of a hollow element that is a structural component for the overall purpose of mounting and that contains holes, cuts, notches or slits through the wall of the hollow vertical element and whose purpose of those holes is not mounting;

3. A mounting stanchion for the mounting of photovoltaic panels where such mounting is manifested through a mounting surface and where mounting stanchion is comprised of a hollow element that is a structural component for the overall purpose of mounting and whose terminal ends may be used for the transit of wires, cables or tubes from photovoltaic panel through stanchion and to other devices;

4. A mounting stanchion for the mounting of photovoltaic panels where such mounting is manifested through a mounting surface and where mounting stanchion is comprised of a hollow element that is a structural component for the overall purpose of mounting and that contains holes, cuts, notches or slits through the wall of the hollow vertical element and whose purpose of those holes is not mounting.
